(19) United States
(12) Patent Application Publication
(10) Pub. No.: US 2010/0008740 A1
(43) Pub. Date: Jan. 14, 2010

(54) ROTARY CUTTER

(75) Inventors: Todd Gerlach, Tualatin, OR (US); Monty Lightner, Milwaukie, OR (US)

Correspondence Address: Schwabe Williamson & Wyatt;PACWEST CENTER, SUITE 1900, 1211 SW FIFTH AVENUE, PORTLAND, OR, 97204, US

(73) Assignee: BLOUNT, INC., Portland, OR (US)

(21) Appl. No.: 12/498,998

(22) Filed: Jul. 7, 2009

Related U.S. Application Data
(60) Provisional application No. 61/080,211, filed on Jul. 11, 2008.

(51) Int. Cl. B23B 51/00; B23Q 5/10; B24B 1/04

(52) U.S. Cl. 408/230; 173/217; 451/48

(57) ABSTRACT

Embodiments provide a helical cutting tool and a helical cutting bit that may be utilized to cut various materials. The helical cutting bit and cutting tool include a variety of features to increase the efficiency of the cutting tool during cutting operations.

### CROSS REFERENCE TO RELATED APPLICATIONS

The present application claims priority to U.S. Provisional Patent Application No. 61/080,211, filed Jul. 11, 2008, titled “Rotary Cutter,” the entire disclosure of which is hereby incorporated by reference in its entirety except for those sections, if any, that are inconsistent with this specification.

### TECHNICAL FIELD

Embodiments of the present invention relate to the field of power tools used for cutting various materials, and, more particularly, to rotary cutting tools.

### BACKGROUND

Cutting various materials such as wood, plastic, and/or foliage is a common task for a wide variety of individuals. For example, construction workers may need to cut through lumber, home improvement projects may require individuals to trim woodwork, and professional landscapers/homeowners may need to prune trees, shrubs, or hedges. These tasks typically require the cutting, trimming, and/or pruning materials having diameters that may vary between a half inch to three and half inches (½ to 3½ inches). Such tasks are labor intensive and often require the use of either hand tools or power tools.

Hand tools and power tools, however, have inherent characteristics which may limit their desirability and practicability for such tasks. Hand tools, such as saws and shears, may be well suited for cutting a variety of materials, but require a significant amount of exertion on behalf of the operator. This may limit their desirability, and in some circumstances, their practicability. For example, in maintaining foliage, pruning shears require increased amounts of exertion as the diameters of branches increase.

In contrast to hand tools, power tools such as chain saws and hedge trimmers may require less operator exertion for cutting, but typically expose the operator to parasitic factors released in the form of vibrations, noise, and heat. These parasitic factors in addition to safety concerns often limit the desirability of power tools. In addition, power tools are typically ill-adapted for cutting more delicate materials, such as smaller diameter branches, thereby limiting their practicability.

### BRIEF DESCRIPTION OF THE DRAWINGS

Embodiments of the present invention will be readily understood by the following detailed description in conjunction with the accompanying drawings. Embodiments of the invention are illustrated by way of example and not by way of limitation in the figures of the accompanying drawings.

FIG. 1 illustrates a rotary cutting tool in accordance with various embodiments;

FIG. 2 illustrates an exploded view of a rotary bearing assembly and cutting tool in accordance with various embodiments;

FIG. 3 illustrates helical cutting bit and rotary bearing assembly in accordance with various embodiments;

FIGS. 4A-B illustrate perspective views of a helical cutting bit in accordance with various embodiments;

FIG. 5 illustrates an enlarged view of a helical flute in accordance with various embodiments;

FIG. 6 illustrates a profile view of a helical cutting bit in accordance with various embodiments;

FIG. 7 is a flow diagram in accordance with various embodiments;

FIGS. 8A-8B illustrate a rotary cutting tool and extension in accordance with various embodiments; and

FIGS. 9A-9B illustrates a cutting bit for use on a rotary cutting tool in accordance with various embodiments.

### DETAILED DESCRIPTION OF EMBODIMENTS

In the following detailed description, reference is made to the accompanying drawings which form a part hereof, and in which are shown by way of illustration embodiments in which the disclosure may be practiced. It is to be understood that other embodiments may be utilized and structural or logical changes may be made without departing from the scope of the present disclosure. Therefore, the following detailed description is not to be taken in a limiting sense, and the scopes of embodiments, in accordance with the present disclosure, are defined by the appended claims and their equivalents.

Various operations may be described as multiple discrete operations in turn, in a manner that may be helpful in understanding embodiments of the present invention; however, the order of description should not be construed to imply that these operations are order dependent.

The description may use perspective-based descriptions such as up/down, back/front, and top/bottom. Such descriptions are merely used to facilitate the discussion and are not intended to restrict the application of embodiments of the present invention.

The terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

For the purposes of the description, a phrase in the form “A/B” or in the form “A and/or B” means (A), (B), or (A and B). For the purposes of the description, a phrase in the form “at least one of A, B, and C” means (A), (B), (C), (A and B), (A and C), (B and C), or (A, B and C). For the purposes of the description, a phrase in the form “(A)B” means (B) or (AB) that is, A is an optional element.

The description may use the phrases “in an embodiment,” or “in embodiments,” which may each refer to one or more of the same or different embodiments. Furthermore, the terms “comprising,” “including,” “having,” and the like, as used with respect to embodiments of the present invention, are synonymous.

In various embodiments, a power tool may be provided that utilizes a rotary cutting bit, such as a ground side cutting bit, and a stabilizer. The rotary cutting bit and stabilizer may operate to increase the safety and efficiency of cutting, trimming, and/or pruning various materials. For example, the cutting bit may be oriented generally inline with a drive motor and include one or more features, such as helical flutes, a heel-grind, and/or a chip breaker. The coaxial disposition of the cutting bit with the motor may result in a more compact and balanced tool. The heel-grind and breaker may, among other things, reduce friction and power consumption by limiting the length and width of the cutting edge that engages the material. Stabilizers may be included to, among other things, resist the rotational forces imparted on the hand tool, facilitate evacuation of debris, and align the hand tool within the kerf, thereby further impacting system efficiency and power consumption. As used herein, kerf may be defined generally as a width of the cut imposed by the cutting bit. A kerf, in various embodiments, will be at least the same as the diameter of the cutting bit, or slightly larger due to displacement of the bit during the cutting operation, the displacement caused by, among other things, vibration and/or wobble.

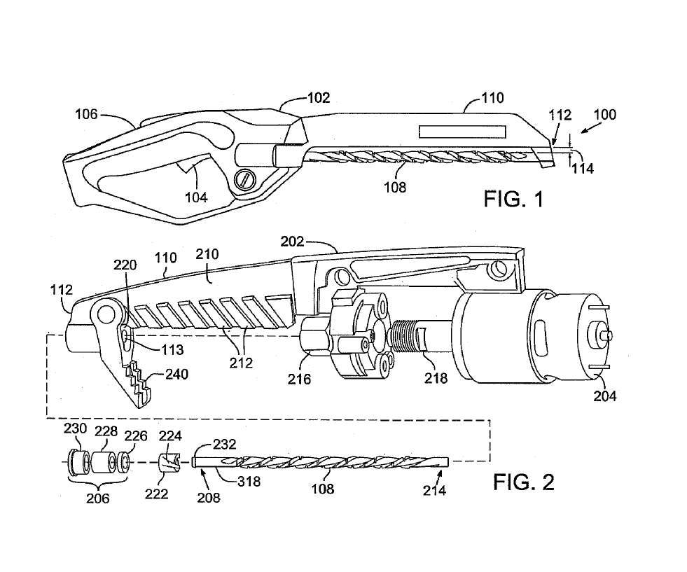

Referring to FIGS. 1 and 2, an embodiment of a cutting tool 100 is illustrated. The cutting tool 100 may include a support frame 202 (see FIG. 2), a housing 102 for the drive motor, an operation initiating device 104 such as a trigger, various gripping features 106 (e.g. handles and hand holds), a power source (not shown), a cutting bit 108, and a stabilizer portion 110.

In various embodiments, the power source may be, for example a direct current (DC) power sources (such as a rechargeable battery) and/or an alternating current (AC) power sources (such as a standard household outlet). The invention is not to be limited in this regard.

In various embodiments, the cutting tool 100 may include a support frame 202 configured to provide rigidity, support, and to some extent vibration dampening properties to the cutting tool 100. The support frame 202 may provide a foundation for attaching various other components, such as the housing 102, motor 204, handle 106, cutting bit 108 and/or the stabilizer portion 110. Alternatively, these components, or others, may be formed integral with the support frame 202. In various embodiments, the support frame 202 may be a back-bone of the cutting tool 100 and generally run the length of the cutting tool 100.

A support member or stabilizer portion 110 may be coupled to the cutting tool 100 and/or support frame 202 in a variety of manners. For example, one end may engage a slot configured on the drive platform or tool housing, it may engage the coupler, or otherwise be secured to the tool. Alternatively, the stabilizer portion 110 may be formed integral with the support frame 202, as illustrated in FIG. 2. The support member 110 may generally span the length of the cutting bit 108 and have a second end including an end member or nose portion 112 adapted to support a rotary bearing assembly 206 and/or an outer end of the cutting bit 208. The nose portion 112 may allow relatively unrestricted rotation of the cutting bit 108 while also providing support during a cutting operation.

In various embodiments, the stabilizer 110 may be configured to provide tool rigidity and alignment, and further to engage the kerf. Once engaged, the stabilizer 110 may help guide the cut, resist skating or drifting, or the tendency of the cutting tool 100 to generally move in the direction that the cutting bit 108 is rotating.

In various embodiments, the stabilizer 110 generally spans a portion of the length of the cutting bit 108 and is positioned a desired distance 114 from the cutting bit. For example, the stabilizer 110 may be positioned about 1-5 mm away from the cutting bit 108. In various embodiments, the distance between the stabilizer and the bit may be less than or equal to the diameter of the bit. Keeping the distance close may provide stability during a cutting operation because the stabilizer 110 enters the kerf shortly after the bit 108. Additionally, the stabilizer 110 may be positioned close enough to the cutting bit 108 that the opportunity for “hang-ups” is reduced. Hang-ups occur when the stabilizer 110 is rotated out of position and is unable to enter the kerf following the cutting bit. As the stabilizer 110 is positioned closer to the cutting bit than 1 mm, chip packing or a reduced out-flow of debris may be encountered. Alternatively, the stabilizer 110 may be positioned further away from the cutting bit 108, which may enable a more aggressive cutting action and enhanced chip flow. In various embodiments the positioning of the stabilizer 110 relative to the cutting bit 108 may be adjustable.

The stabilizer portion 110 or guide fence may be a vertically oriented stabilizer extending radially from the cutting bit 108. In various embodiments, the stabilizer portion 110 may have a minimum thickness of about 3 mm at an upper portion 210 of the stabilizer 110 and an overall thickness between about 4.0 mm and about 5.5 mm. In various embodiments, the various thicknesses may be determined based upon the diameter of the cutting bit 108; for example, at least a portion of the stabilizer portion is less than the diameter of the cutting bit; or for example, the thickness may be tapered from a first end to a second end. The thicknesses may be set so that they are slightly less than the kerf created by the cutting bit 108. This may reduce friction between the stabilizer 110 and the kerf walls, provide volume for the egress of debris, and resist the tendency of the cutting tool 100 to skate in the rotational direction of the cutting bit 108.

In various embodiments, the stabilizer 110 may include one or more channels or grooves 212 disposed on either side of the stabilizer 110. These grooves 212 may also provide an exit point for debris as it is removed from the material being cut. The grooves 212 may be disposed at an angle with respect the cutting bit so as to facilitate removal of debris during operation. While facilitating removal of debris, the angled grooves 212 also provide enhanced structural integrity that may increase resistance to bending or warping of the cutting bit and stabilizer while in use. The grooves 212 may be configured to provide a chip clearance to prevent clogging and/or packing of debris against the kerf walls. The grooves 212 may be positioned on the stabilizer 110 along the length of the cutting bit 108.

In various embodiments, a first distal end 214 of the cutting bit 108 may engage the housing 102 in a variety of manners, including coupling to the motor output shaft 218 by means of a coupler 216, such as a chuck, collet, quick release coupler, etc. The cutting bit 108 may be disposed coaxially with the motor output shaft 218, or alternatively, may be offset from an axis of the motor output shaft 218. When the cutting bit 108 is disposed coaxially with the motor output shaft 218, cylindricity between the various couplings may be matched to prevent or substantially reduce undesirable vibration harmonics.

In various embodiments, a second distal end 208 of the cutting bit 108 may engage a nose portion 112 of the stabilizer 110. In various embodiments, the nose portion 112 may be a housing having an aperture 113 configured to receive the second distal end 208. In various other embodiments, the nose portion 112 may include other supporting structures. The nose portion 112 may also include a backstop or shoulder 220, which may serve to help contain the rotary bearing assembly 206 in the nose portion 112 of the stabilizer 110. In addition to helping contain the rotary bearing assembly 206, the shoulder 220 may also serve to resist the flow of debris into the rotary bearing assembly 206 during cutting operations. This may prevent unwanted chip packing in the nose of the cutting tool 100.

The aperture 113 may pass through the shoulder 220 of the nose portion 112 may be sized to allow a portion of the bit to pass through and not interfere with rotation of the bit. In various embodiments, the shoulder 220 may be configured with a specific key-hole bore that enables a cutting bit 108 and certain components coupled to the bit to pass through the nose portion 112 when properly aligned with the key-hole. For example, a cutting bit may include a vaned chip deflector 222, as will be discussed further herein. The vaned chip deflector 222 may include one or more vanes 224 that correspond to the key-hole bore. The vanes 224 may be aligned with the key-hole bore to enable the cutting bit 108 and vaned chip deflector 222 to be removed from the cutting tool 100. During operation, due to the speed at which the vaned chip deflector 222 and cutting bit rotate 108, chips may be blown away from the nose, which in turn may help prevent undesirable packing.

In various embodiments, the second distal end 208 of the cutting bit 108 may engage or be supported by the rotary bearing assembly 206. The rotary bearing assembly may include one or more seals 226, a bearing 228 (such as a needle roller bearing), and an end-cap 230 adapted to hold the bearing assembly against the shoulder in a manner that allows rotation of the bit 108 along with, for example a bearing inner race, while holding the outer portion of the bearing stationary. In one embodiment, the end-cap may hold a bearing outer race stationary by forcing it against the shoulder 220. The rotary bearing assembly 206 may include more or fewer components without deviating from the scope of the invention.

The end-cap 230, in various embodiments, may couple to the stabilizer portion 110 or nose portion 112 in a variety of manners and encase the other rotary bearing assembly components 226, 228 within the nose portion 112. The end-cap 230 may include one or more threads that engage corresponding threading within the nose portion of the stabilizer. Alternatively, the end-cap 230 may include one or more press or interlock fittings that interface with an edge, lip or corresponding pattern within the nose portion 112, the disclosure is not to be limited in this regard. While the end-cap 230 encloses the rotary bearing assembly 206 within the nose portion 112 and prevents debris from interfering with the bearing assembly 206, it additionally may provide access for removal, replacement, or cleaning of the rotary bearing assembly 206 or cutting bit 108.

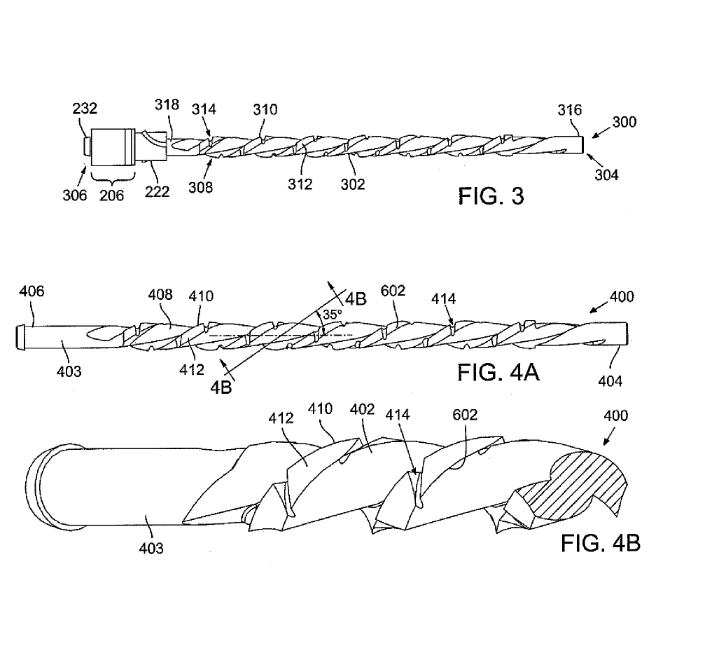

The rotary bearing 228, in various embodiments, may be a needle roller bearing with a machined outer ring. The bearing 228 may be machined to have a clearance fit between the inner wall of the nose portion to facilitate removal of the rotary bearing assembly 206 and/cutting bit 108, while providing a stable platform to prevent wobble of the cutting bit 108 during operation. The rotary bearing 228 may be disposed adjacent to one or more seals 226, for example, a radial shaft seal. In various embodiments, the seal 226 may be configured to help prevent the ingress of debris into the bearing assembly 206. In various embodiments, the bearing 228 and seal 226 may be engaged with the bit by way of a flared or barbed end 232 of the cutting bit 108 in order to secure the bearing assembly 206 to the cutting bit 108, as illustrated in FIG. 3.

Referring to FIGS. 2 and 3, a cutting bit 108 may include a chip deflector 222 such as a vaned chip deflector that is configured to reduce chip packing at the nose portion 112 of the stabilizer 110 and prevent contamination of the rotary bearing assembly 206. The vaned chip deflector 222 includes one or more vanes 224, that when rotated, are configured to agitate chips to facilitate their removal. For example, given a cutting bit 108 with a helical cutting edge, loose debris will be advanced toward the second distal end 208 of the cutting bit 108 based upon the direction of the helical grooves. This may lead to chip packing in the nose 112 of the stabilizer 110 as more and more debris is forced to this position. In various embodiments, the chip defector 222 may be similar to an impeller that is configured to provide a reverse airflow or vortex based on the configuration of one or more vanes 224. In other embodiments, such air flow may be generated with paddles or other features. The reverse airflow may also facilitate removal of loose debris. Chip deflectors in accordance with various embodiments may be coupled towards either the first distal end and/or the second distal end to help reduce chip packing or buildup.

Still with reference to FIG. 2, a view of a helical cutting bit 108, a nose portion 112, and a support member 110, is illustrated in accordance with various embodiments. In the illustrated embodiment, the cutting bit 108 may be rotatably coupled to the drive mechanism 204 of the tool at a first distal end 214 and supported at a second distal end 208 by nose portion 112 and rotary bearing assembly 206. The rotary bearing assembly 206 allows rotational movement of the cutting bit 108 while preventing lateral movement. The stabilizer 110 may also include a branch support 240, which is adapted to engage a branch or other piece of debris being cut. In various embodiments, the support 240 may provide for cutting leverage, resist axial movement caused by the cutting forces endured, cause the wood being cut to stay away from the nose 112 to avoid congestion, and/or help reduce drifting during operation. In various embodiments the branch support 240 may include a saw tooth type surface to help enhance engagement with the debris.

In various embodiments, the branch support may be foldable from an engaging position (illustrated) to a non-engaging position. In various embodiments, the support may be biased, such that as the support member is pushed into a bush, for example, the branch support will fold towards the cutting bit to facilitate penetration of the bush, but will be biased back to the engagement position prior to cutting. In various embodiments, the branch support may also be adapted to fold away from the bit in order to cause the branch support to be in a non functional and non-engaged position. Again, this position may be beneficial if the branch support is not required, or to facilitate positioning of the tool prior to a cutting operation. In various embodiments, the tool may include releasable locking mechanisms configured to hold the branch support in either the engaged or non-engaged positions.

In various embodiments, the stabilizer 110 may not only be utilized to support the cutting bit 108 at one or both of the ends, but it may also help guide the cutting bit 108 through a cut, and oppose various axially directed forces. The support member 110 may be made out of any suitable material such as plastic, metal, or other suitable durable materials, and/or it may be treated or coated with certain materials that may enhance cutting effectiveness (e.g. coat with a friction reducing material such as a Teflon or titanium nitride coatings).

In various embodiments, the support member 110 may have an integrated coupler that is configured to couple the support member and end member/s to an existing hand held power tools (e.g. cordless drill). The cutting bit may be secured in the rotational support members and coupled to the drive of the hand held tool. Such coupling may be direct from the tool to the distal end of the cutting bit, or through an intermediate coupler such as a flex coupler.

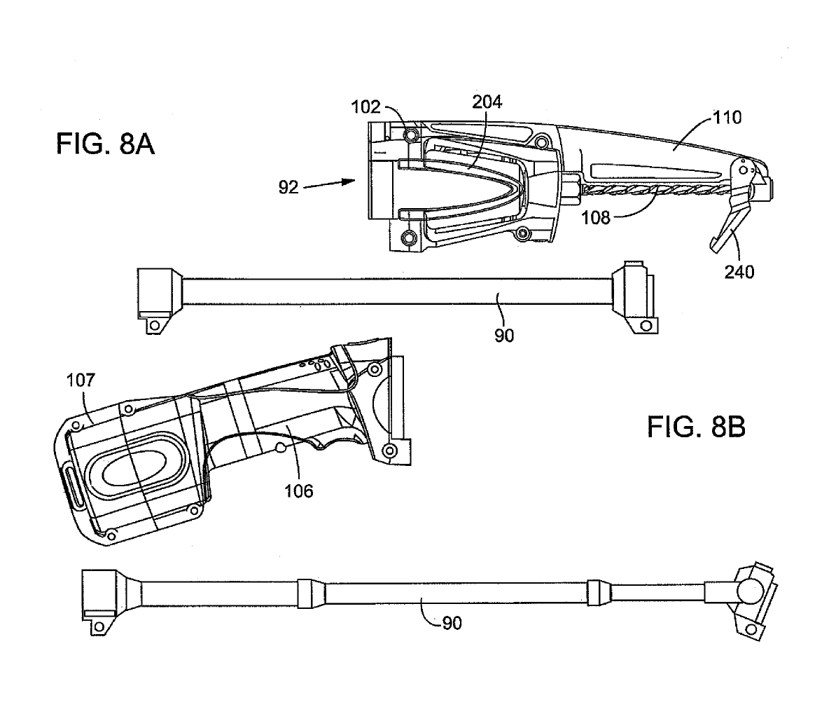

In alternative embodiments, a pole or extension may be configured to couple between the cutting tool and the hand held portion. This may enable a user to reach, for examples, branches in high trees that would otherwise require ladders, or steps. FIG. 8A illustrates an embodiment of a rotary cutting tool used in conjunction with a pole extension 90, and FIG. 8B illustrates a pole extension that is extendable in accordance with various embodiments. In various embodiments, a head portion of the tool 92 may be removably coupled to the handle 106 via a releasable interlock mechanism. The head portion 92, which in various embodiments may include the motor 204, housing 102, bit 108 and stabilizer 110, may be adapted to couple to a first end of extension 90. Handle 106 and power source 107 (e.g. battery or A/C power cord) may be coupled to a second opposite end of extension 90. Extension 90 may have an electrical linkage or path way extending from the first end to the second end, such that the Extension 90 may electrically couple the Handle 106 and power source 107 to the a head portion of the tool 92.

In various embodiments, the motor 204 may be positioned at the same end of the extension as the power source 90, and a mechanical linkage, such as a flex drive, may operably couple the motor 204 to the bit 108. In various embodiments, a support hook 240 may be used to help steady the device. As illustrated in FIG. 8B, in various embodiments, the extension may be extendable and retractable to accommodate different heights or reach requirements. In various embodiments, the extension 90 may be made out of aluminum, carbon fiber, fiberglass, or other light weight material having a generally rigid structure.

In various embodiments, a cutting bit 108 may comprise a variety of materials and coatings dependent upon the cutting bit's intended application. For example, the cutting bit material may include various types of steel such as, but not limited to, low carbon steel, high carbon steel, high speed steel, cobalt steel, and various other alloys. In various other embodiments, cutting bits may utilize other materials such as tungsten carbide and polycrystalline diamond. Additionally, in various embodiments the cutting bits may utilize a variety of coatings such as black oxide, titanium nitride, titanium aluminum nitride, titanium carbon nitride, diamond powder, zirconium nitride, as well as Teflon based coatings. Various other materials, coatings, and combinations thereof are possible and that the disclosure is not to be limited in this regard.

In various embodiments (e.g. those previously discussed), the stabilizer 110 and nose support 112 may effectively support a cutting bit 108 at both the first distal end 214 and the second distal end 208. This support may allow the design of the bit to have a longer in cutting length, as compared to traditional cantilevered cutting bits, and may also enable the use of varying diameters, including throughout the cutting bit. In various embodiments, a reduction in shank diameter (e.g. the cylindrical member diameter) may help reduce power consumption during cutting due to a narrower kerf, and can tend to reduce the overall rotating mass, thereby improving system efficiency.

In various embodiments, the reaction forces generated during cutting may not only pull the bit 108 axially into the wood, but it may also tend to push the bit out of the cut perpendicular to the axis. The stabilizer 110, once confined by the kerf walls will help counteract any undesirable forces, such as this aforementioned “drifting” or “skating” action. This may reduce operator effort and improve cutting precision. Additionally, in various embodiments, unpredictable reactions forces, such as kickback are also eliminated by virtue of the cross-cutting motion of the cutting bit 108.

Referring to FIG. 3, a cutting bit 300 is illustrated in accordance with various embodiments. The cutting bit may include a generally cylindrical body 302 having a first distal end portion or area 304 and a second distal end portion or are 306, one or more helical flutes 308 forming one or more helical cutting edges 310, heel relief geometry 312, depth gauges 602 (see FIG. 6), one or more breakers 314, and/or other surface features. In various embodiments, the first distal end 304 of the cutting bit 300 may include a “non-featured” portion 316 configured to engage a drive coupler (e.g. chuck, collet, etc.) for rotating the bit 300. The second distal end 306 may also include a non-featured portion 318. The non-featured portion 318 of the second distal end may 306 be configured to engage a roller bearing assembly 206, or other friction reducing elements. In various embodiments, the second distal end 306 may additionally include one or more protrusions barbs 232 configured to restrict certain movement of the rotary bearing assembly 206 and vaned chip deflector 222. As used herein, a “non-featured portion” is used to refer to portions of the bit that do not actively assist in the cutting operation, but are those portions used to couple the bit to the support or the drive mechanism. These “non-featured” portions may, in various embodiments be smooth, or have some sort of surface changes that may enhance coupling of the bit to the tool (e.g. hexagonal shaped for quick coupling couplers, splined ends to increase grip, etc.)

In various embodiments, the non-featured end portions 316, 318 of the generally cylindrical body 302 may be a “trail-out” portion formed while creating one or more helical flutes 308. The non-featured ends 316, 318 at the first 304 and second 306 distal ends of the cylindrical body 302 increase the total area where the bit may engage, for example, the collet and rotary bearing assembly 206. In various embodiments, the diameter of the non-featured ends 316, 318 may be reduced from about 6.3 mm to 5 mm, and in some cases to 2.7 mm and less. Reducing the diameter may minimize missing material due to the helical flute trail-out and improve alignment with the motor and rotary bearing assembly 206.

Referring to FIGS. 4A and 4B, a perspective view of a cutting bit 400 is illustrated. In various embodiments, one or more helical flutes 408 may be formed in or on the cylindrical body 404 between the first distal end portion 404 and the second distal end portion 406. The helical flutes 408 may define the helical cutting edges 410. Helical flutes 408 may be a spiral feature disposed in the generally cylindrical body 403 at a helix type angle. In various embodiments, the helix angle may be between about 35 degrees and 70 degrees from the axis of the cylindrical body 403. One or more helical flutes 408 may be utilized on the generally cylindrical body 403. In various embodiments, the helical flutes 408 may be spaced equally apart around the periphery of the cylindrical body 403, whereas in other embodiments the spacing may be varied. The one or more flutes 408 may provide a volume for debris to evacuate from the bit 400 during cutting operations.

In various embodiments the flute 408 may be set as desired to improve chip flow and cutting efficiency. While the shank diameter can vary as desired, in one embodiment where a roughly 6.35 mm shank diameter bit is used, the depth 604 (see FIG. 6) of the flute 408 may be approximately 1 mm to 2.5 mm to provide adequate chip flow volume while maintaining a minor diameter between approximately 2 mm to 3 mm to ensure adequate bit rigidity for cutting. In various embodiments, the depth may be the ratio of approximately 0.15 to 0.40.

The one or more flutes 408 may form a substantially continuous cutting edge 410 along at least a portion of the bit. The one or more cutting edges 410, in various embodiments, may extend from the first distal end portion 404 of the cylindrical member 403 at a slightly acute relief angle and follow a generally helical path around the circumferential portion of the cylindrical member 403 to the second distal end portion 406. The helical path, in various embodiments, may be oriented in a generally clockwise manner, or alternatively, in a generally counter-clockwise manner with respect to root end.

In various embodiments, the helical flutes 402 may include one or more breakers 414, for example, a chip breaker, adapted to interrupt or break the material being cut into smaller sizes or chips. This may help with cutting efficiency and reduce the potential for clogging. One or more chip breakers 414 may be ground into the cutting edge 410 along the bit. The shape of the breakers may be “U” shaped, “V” shaped, or some other geometrical configuration. Again, while the various dimensions may be set as desired, for a 6.35 mm shank, the depth of the breaker may be in the range of 0.5 mm to 1.5 mm, and in some embodiments the ratio of breaker depth to shank diameter can be in the range of approximately 0.08 to 0.24.

In various embodiments, each helical flute 408 may form a substantially continuous cutting edge. The total length of engagement of the edge in the material being cut can have a significant impact on the power required to perform cutting operations. To better match the power consumption of the rotary bit to the power supply (e.g. 12 volt or 18 volt cordless) one or more chip breakers 414 are introduced into the helical cutting edges 410. The breakers 414 or serrations reduce the total length of the edge engaged, and thus reduce the amount of power required to drive the cutting edge 410 through the material being cut. The breaker 414 in various embodiments may be a “v” notch imposed on the helical cutting edges. The breakers 414 may be disposed at equal distances along the cutting edges 410 of the helical flutes 402. In various embodiments, the chip breakers 414 may be disposed at an angle relative to the rotational axis of the bit 400. As illustrated, the breakers 414 are disposed at an angle of roughly 90 degrees to a plane bisecting the axis of rotation.

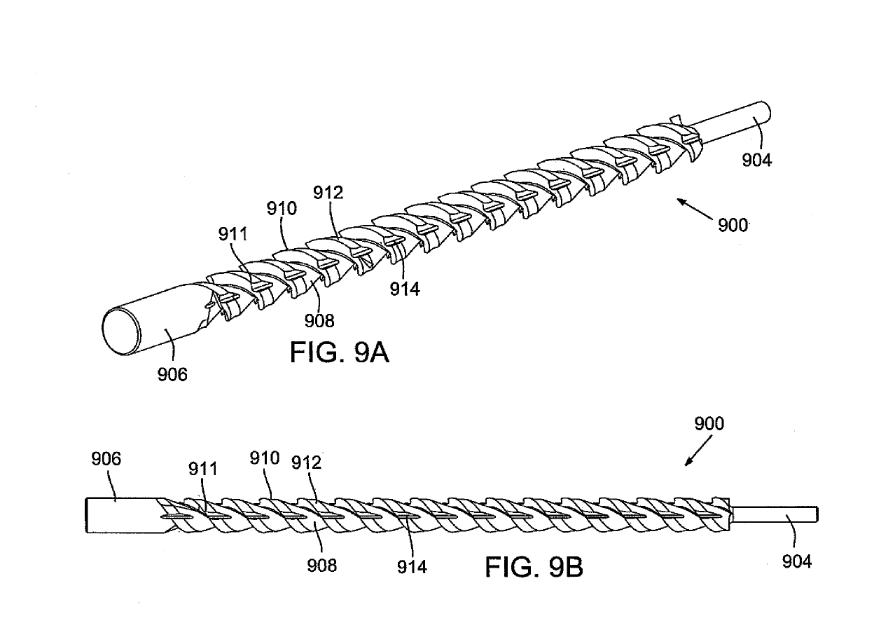

As illustrated in FIG. 9, in various embodiments, the breakers 914 may be disposed along a path that is generally parallel to the axis of rotation of the bit 900. Referred to herein as axial breakers 914, they may interrupt the cutting edge 910 of the flute 908, and extend across heel relief 912. In various embodiments, to alleviate or soften a potentially aggressive point created at the intersection of the chip breakers (which could cause unwanted skating) the edges of the leading portion of the chip breaker intersection with the cutting edge 910 may be tapered or softened, as illustrated by reference number 911. In one embodiment, three sets of axial chip breakers may be disposed about the circumference of the bit at a roughly 120 degree offset. Further, more or less axial chip breakers may be used, and they may run all or only a portion of the axial length of the bit. In various embodiments, the axial breakers may be used alone or in conjunction with angled chip breakers.

Referring back to FIGS. 4A and 4B, in various embodiments, the cutting bit 400 may include a heel grind 412, such as a hollow-heel grind. The heel 412 may be formed by a second grind disposed behind the cutting edges 410 of the helical flutes 402. The heel grind 412 intersects the outside diameter of the cylindrical body 403 to create the cutting edges 410 and intersects the helical flutes 408 to provide a relief behind the cutting edge 410. A relief behind the cutting edge 410 may help to reduce the amount that the cutting bit 400 that is in contact with the material being cut thereby reducing friction, power consumption, and improving efficiency. Additionally, because there is a decrease in friction, there may be a corresponding decrease in heat, which may prolong the life of various components. In various embodiments, the line of intersection with the helical flutes 408 may be diametrically set below the cutting edge between approximately 0.12 mm and 0.38 mm to act as a depth gauge 602 (see FIG. 6) during operation. In various embodiments, the surface of the heel grind 412 may be concave, beveled, tapered or hollow in shape to provide additional clearance and minimize contact with the material being cut. In various embodiments, the depth gauge 602 may be set as an approximate ratio of 0.02 to 0.10.

In various embodiments, the cutting edge 410 may be formed from the root of a leading flute to the cutting edge of an adjacent flute, ground in a helical or spiral manner. In various embodiments, the geometries of the cutting bit 400 may be varied including shank diameter (cylindrical body 403), the number of flutes 408, helix direction, helix angle, rake angle, relief angle geometry, land geometry, and flute depth 604. Various ones of these geometries may be varied and or optimized according to the manner or application in which the cutting bit is to be utilized.

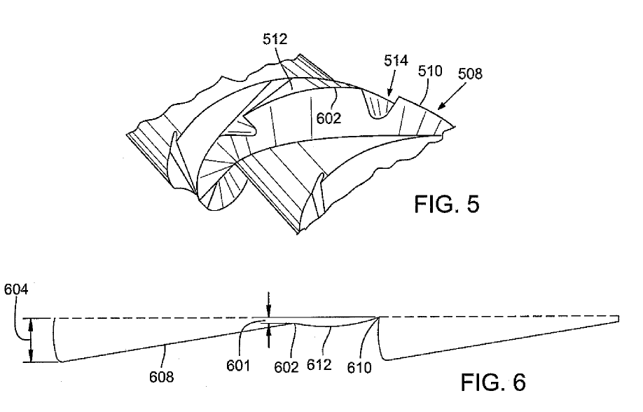

FIG. 5 illustrates a perspective view of a cutting bit in accordance with various embodiments. A helical flute 508 may include a helical cutting edge 510, a breaker 514, a hollow-grind heel 512, and a depth gauge 602.

FIG. 6 illustrates a two-dimensional segmented profile view of a rotary cutting bit in accordance with various embodiments. The bit may include a helical cutting flute 608 and a cutting edge 610, further having a flute depth 604. The bit may also have a hollow-grind or recessed portion 612 and a depth gauge 602, which may generally define a depth gauge setting 601

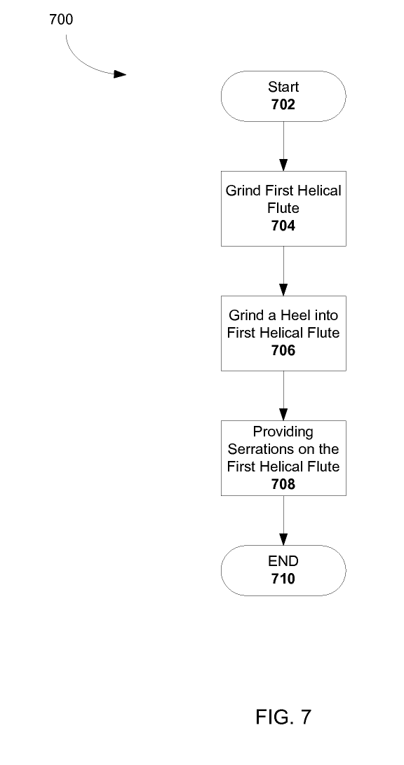

Referring to FIG. 7, a flow chart illustrating a process 700 for producing a cutting bit in accordance with various embodiments is shown. In various embodiments, the process may begin at block 702 and proceed to block 704 by disposing a first helical flute in or on a wall of a cylindrical member at a helix angle, such as by grinding. In various embodiments, the helix angle may be between approximately 30 degrees and approximately 60 degrees. The first helical flute may designed to provide a determined kerf, for example, a kerf of approximately 6.35 mm, and a volume for debris dislodged during a cutting operation. In various embodiments, the cylindrical member may be a rotary bit blank of high speed steel or other suitable material. The grinding of the first helical flute may stopped prior to reaching the distal ends of the cylindrical member. This may provide one or more non-featured ends that are adapted to couple to a rotary bearing assembly or alternatively a collet of a motor.

Subsequent to creating the first helical flute in or on the cylindrical member, the process may continue to block 706. The process may continue by creating a heel into the first helical flute to provide, for example by grinding, a cutting edge on the first helical flute. Additionally, the heel may be configured to act as a depth gauge for the cutting edge, thereby limiting the amount of material the cutting edge removes in a cutting operation. Grinding the heel into the helical flute may result in a hollow grind between the helical cutting edge and the heel. A recessed hollow grind, in various embodiments, may provide additional clearance and minimize contact with the material being cut.

The process may continue to block 708. At block 708, one or more serrations or breakers may be formed on the first helical flute. The one or more serrations may interrupt contact of the first helical flute with the material being cut. In various embodiments the serrations may be a chip breaker. The process 700 may then terminate at block 710.

In various embodiments, more than one helical flute may be ground into the wall of the cylindrical member. For example, a second and a third helical member may be ground in the cylindrical member to provide additional cutting edges. The additional cutting edges may be further formed in accordance with the process described above. For example, the second and third helical flutes may be further processed to provide a heel and one or more serrations. The disclosure is not to be limited in this regard.

Although certain embodiments have been illustrated and described herein, it will be appreciated by those of ordinary skill in the art that a wide variety of alternate and/or equivalent embodiments or implementations calculated to achieve the same purposes may be substituted for the embodiments shown and described without departing from the scope of the present invention. Those with skill in the art will readily appreciate that embodiments in accordance with the present invention may be implemented in a very wide variety of ways. This application is intended to cover any adaptations or variations of the embodiments discussed herein. Therefore, it is manifestly intended that embodiments in accordance with the present invention be limited only by the claims and the equivalents thereof.

1. A rotary cutting bit, comprising:
a cylindrical body having a first distal end portion and a second distal end portion;
a helical flute formed in or on a wall of the cylindrical body between the first distal end portion and the second distal end portion, wherein the helical flute defines a helical cutting edge around the periphery of the cylindrical body;
one or more chip breakers disposed in the helical flute, wherein the plurality of breakers are configured to form a plurality of helical cutting members from the helical cutting edge

2. The apparatus of claim 1, further comprising a second helical flute formed in or on the wall of the cylindrical body between the first distal end portion and the second distal end portion and disposed generally opposite the helical flute, wherein the second helical flute defines a second helical cutting edge around the periphery of the cylindrical body.

3. The apparatus of claim 1, wherein the breakers are “V” shaped, “U” shaped or have a generally flat bottom.

4. The apparatus of claim 1, wherein the plurality of breakers are evenly spaced along the helical flute.

5. The apparatus of claim 1, wherein the helical flute further includes a depth gauge.

6. The apparatus of claim 5, wherein the helical flute includes a recessed portion between the depth gauge of the helical flute and the helical cutting edge of the helical flute.

7. The apparatus of claim 6, wherein the recessed portion is a concave recessed portion.

8. The apparatus of claim 1, wherein the cylindrical body has a length to diameter ratio that is between approximately 20 to 25.

9. The apparatus of claim 1, wherein the helical flute includes a helix angle between approximately 35 degrees and approximately 70 degrees.

10. The apparatus of claim 1, wherein the helical flute formed in the wall of the cylindrical body has a depth in the range of approximately 1.0 mm to 2.5 mm.

11. A rotary cutting system comprising:
a cutting bit having a first distal end portion and a second distal end portion, wherein the cylindrical member comprises a plurality of helical cutting members disposed around a periphery of the cutting bit generally between the first distal end portion and the second distal end portion;
a stabilizer having an outer end portion adapted to couple with the second distal end portion of the cutting bit such that the cutting bit may be rotatably supported by the end portion, the stabilizer having a kerf engaging portion having a width that is generally less than or equal to an overall width of the cutting bit;
a motor coupled to the stabilizer, and further drivably coupled to the first distal end portion of the cutting bit, wherein the motor is configured to rotatably drive the cutting bit about an axis.

12. The rotary cutting system of claim 11, wherein the kerf engaging portion of the stabilizer includes one or more grooves adapted to help remove material and provide structural strength to the stabilizer.

13. The rotary cutting system of claim 11, wherein the motor is disposed generally coaxially with the axis of the cutting bit and configured to engage the first distal end portion.

14. The rotary cutting system of claim 11, further comprising a chip deflector coupled to the second distal end portion and/or the first distal end portion of the cutting bit, wherein the chip deflector includes one or more vanes configured to cause material deflection.

15. The rotary cutting system of claim 11, further comprising a bearing assembly configured disposed on the second distal end portion of the cutting bit, wherein the bearing assembly is disposed within the outer end portion of the stabilizer.

16. The rotary cutting system of claim 15, wherein the outer end portion of the stabilizer includes a shoulder portion adapted to help retain the bearing assembly in a manner that allows the cutting bit to rotate relative to the stabilizer and help retain the bearing in the outer end portion

17. The rotary cutting system of claim 16, wherein the shoulder portion includes one or more channels, wherein the one or more channels are configured to align with one or more vanes of a chip deflector to remove the cutting bit from the outer end portion of the stabilizer.

18. The rotary cutting system of claim 15, wherein the bearing assembly comprises:
a threaded end cap configured to engage the outer end portion of the stabilizer and hold the bearing assembly against the shoulder portion.

19. The rotary cutting system of claim 11, further comprising brace member coupled to the stabilizer, wherein the brace member is configured to provide stability during a cutting operation.

20. The rotary cutting system of claim 11, wherein a clearance is disposed between the cylindrical member and stabilizer of at least 1 mm.

21. The rotary cutting system of claim 11, wherein the plurality of helical cutting members of the cylindrical member are separated by a chip breaker, and the cutting bit further includes a depth gauge separated from the cutting edge by a hollow heel grind.

22. The rotary cutting system of claim 11, wherein the stabilizer includes a back bone an inner end opposite the outer end portion that is configured to couple to the motor housing in a manner that helps provide rigidity.

23. The rotary cutting system of claim 11, further comprising an extension adapted to operably couple a power source to the motor, bit and stabilizer and allow for a longer reach of the system.

24. A method, comprising:
grinding a first helical flute into a wall of a cylindrical member at a helix angle, wherein the first helical flute provides a volume for material dislodged during a cutting operation;
grinding a heel into the first helical flute to provide a cutting edge on the first helical flute, wherein the heel is configured as a depth gauge; and
forming one or more serrations on the first helical flute, wherein the one or more serrations interrupt contact of the first helical flute with the material.

25. The method of claim 24 further comprising:
grinding a second helical flute into the wall of the cylindrical member at the helix angle, wherein the second helical flute is disposed opposite the first helical flute

26. The method of claim 25, further comprising:
grinding a third helical flute into the wall of the cylindrical member at the helix angle, wherein the second helical flute is disposed between the first helical flute and the second helical flute.

27. The method of claim 24, wherein grinding the first helical flute further comprises grinding the first helical flute into the wall of the cylindrical member at a helix angle between approximately 35 degrees and approximately 70 degrees.

28. The method of claim 24, wherein grinding the first helical flute further comprises stopping the grinding prior to reaching a distal end of the cylindrical member.

29. The method of claim 24, wherein grinding the first helical flute further comprises grinding the first helical flute into the wall of the cylindrical member to provide a kerf of approximately 6.35 mm.
